(19) United States
(12) Patent Application Publication
(10) Pub. No.: US 2026/0044188 A1
(43) Pub. Date: Feb. 12, 2026

(54) DESKTOP ADJUSTABLE HARDWARE BRACKET

(71) Applicant: Shenzhen Joyhong Tech Co.,Ltd, Shenzhen (CN)

(72) Inventor: Jianping Wang, Shenzhen (CN)

(21) Appl. No.: 19/361,691

(22) Filed: Oct. 17, 2025

(30) Foreign Application Priority Data
Sep. 26, 2025 (CN) 202522079288.2

(51) Int. Cl. G06F 1/16

(52) U.S. Cl. CPC G06F 1/166

(57) ABSTRACT

A desktop adjustable hardware bracket is provided, including a bottom plate. An upwards bent first flange portion is arranged at one end of the bottom plate, and a U-shaped slot is provided in another end of the bottom plate. First shaft sleeves formed by inwards curling a plate body are arranged on two sides of a notch of the U-shaped slot. An interior of the U-shaped slot and interiors of the first shaft sleeves are connected with a supporting plate through a stop-at-any-position rotating shaft mechanism mounted. A backwards bent second flange portion is arranged at one end of the supporting plate. By the arrangement of the stop-at-any-position rotating shaft mechanism, a first meshing tooth on an outer side of a T-shaped shaft lever is used to mesh with second meshing teeth inside the first shaft sleeves.

### TECHNICAL FIELD

The present disclosure relates to the technical field of electronic device brackets, and in particular, to a desktop adjustable hardware bracket.

### BACKGROUND

In daily life and office scenarios, desktop brackets are widely used to support electronic devices such as a tablet computer and a laptop computer, to improve the comfort level and convenience of use. However, traditional desktop adjustable hardware brackets face numerous problems when they are folded to adjust an angle. Because of lack of reliable stop-at-any-position structures, it is difficult for many brackets to stably stop at arbitrary angles. Some brackets require additional locking devices, which makes operations complicated. Moreover, due to unstable supporting, angles often vary during use, which affect the user experience. In addition, due to poor anti-slip performance of some brackets, electronic devices easily slide or even fall off when they are placed. This poses a safety risk and inadvertently reduces the practicality of the desktop brackets.

### SUMMARY

The present disclosure aims to provide a desktop adjustable hardware bracket, to address the issues mentioned in the above background section.

To achieve the above objective, the present disclosure provides the following technical solutions: a desktop adjustable hardware bracket includes a bottom plate. An upwards bent first flange portion is arranged at one end of the bottom plate, and a U-shaped slot is provided in another end of the bottom plate; first shaft sleeves formed by inwards curling a plate body are arranged on two sides of a notch of the U-shaped slot; an interior of the U-shaped slot and interiors of the first shaft sleeves are connected with a supporting plate through a stop-at-any-position rotating shaft mechanism mounted; a backwards bent second flange portion is arranged at one end of the supporting plate; a second shaft sleeve is formed at another end of the supporting plate by inwards curling a plate body; and the second shaft sleeve is in sleeving connection with the stop-at-any-position rotating shaft mechanism.

In a preferred solution of the present disclosure, the stop-at-any-position rotating shaft mechanism includes two T-shaped shaft levers that are respectively in interpenetrating connection to the interiors of the two first shaft sleeves; a first meshing tooth is arranged on an outer side of a lever body of each T-shaped shaft lever; the first meshing tooth is in meshing connection with a second meshing tooth arranged inside each first shaft sleeve; an insertion shaft body is arranged at one end of the lever body of the T-shaped shaft lever; a friction sleeve made of a polyformaldehyde material sleeves the insertion shaft body; and the friction sleeve is sleeved inside the second shaft sleeve.

In a preferred solution of the present disclosure, a positioning protrusion is arranged on an inner side of one end of each first shaft sleeve; and positioning grooves that adapt to the positioning protrusions and limit a rotation range are arranged on outer sides of two ends of the second shaft sleeve.

In a preferred solution of the present disclosure, four corners of a bottom of the bottom plate are fixedly connected with a plurality of silicone pads; and a top of the bottom plate and an inner side of the first flange portion are fixedly connected with first anti-slip silicone sheets.

In a preferred solution of the present disclosure, a hollow slot is formed in a surface of the supporting plate; and the surface of the supporting plate and a surface of the second flange portion are fixedly connected with second anti-slip silicone sheets.

In a preferred solution of the present disclosure, the bottom plate, the supporting plate, and the insertion shaft body are made of metal materials.

Compared with the prior art, the present disclosure has the beneficial effects below:
1) By the arrangement of the stop-at-any-position rotating shaft mechanism, the first meshing teeth on the outer sides of the T-shaped shaft levers are used to mesh with the second meshing teeth inside the first shaft sleeves, and the friction sleeves that sleeve the T-shaped shaft levers and are made of the polyformaldehyde materials rub the interior of the second shaft sleeve. In addition, a stop-at-any-position function of the desktop adjustable hardware bracket is implemented by using cooperation of meshing teeth and a friction force between friction sleeves and metal shaft levers, without an additional locking device, so that the desktop adjustable hardware bracket is easy to operate and can stably stop in any angle. A problem that an angle of a traditional bracket easily varies or the traditional bracket is complicatedly locked is solved.
2) The silicone pads are arranged at the bottom of the bottom plate, and the anti-slip silicone sheets are arranged at the top of the bottom plate, on the inner side of the first flange portion, and on the surface of the supporting plate and the surface of the second flange portion, so that the anti-slip performance of the bracket is effectively improved, sliding or falling off of a placed electronic device is avoided, and the safety of use is improved. The positioning protrusions on the inner sides of the first shaft sleeves adapt to the positioning grooves on the outer side of the second shaft sleeve to limit the rotation range, so that the rotation range of the bracket is orderly limited. By the use of the bottom plate, the supporting plate, and the T-shaped shaft levers that are made of the metal materials, the structural strength and durability of the bracket are ensured, so that wear of a rotating component is reduced; the service life of the bracket is prolonged; the problems that the traditional bracket has poor anti-slip performance and the rotating component is easy to wear are solved; and the practicability of the bracket is improved.

### BRIEF DESCRIPTION OF THE DRAWINGS

FIG. 1 is a schematic structural diagram of the present disclosure;

FIG. 2 is a first schematic structural diagram of the present disclosure;

FIG. 3 is a schematic structural diagram of the present disclosure after folding;

FIG. 4 is a schematic exploded diagram of the present disclosure; and

FIG. 5 is a first schematic exploded diagram of the present disclosure.

In the drawings: 100: bottom plate; 110: first flange portion; 120: U-shaped slot; 130: first shaft sleeve; 131: positioning protrusion; 140: silicone pad; 150: first anti-slip silicone sheet; 200: stop-at-any-position rotating shaft mechanism; 210: T-shaped shaft lever; 211: insertion shaft body; 220: first meshing tooth; 230: second meshing tooth; 240: friction sleeve; 300: supporting plate; 310: second flange portion; 320: second shaft sleeve; 321: positioning groove; 330: hollow slot; and 340: second anti-slip silicone sheet.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all the embodiments. Based on the embodiments of the present disclosure, all other embodiments obtained by those of ordinary skilled in the art without creative efforts fall within the protection scope of the present disclosure.

### Embodiment 1

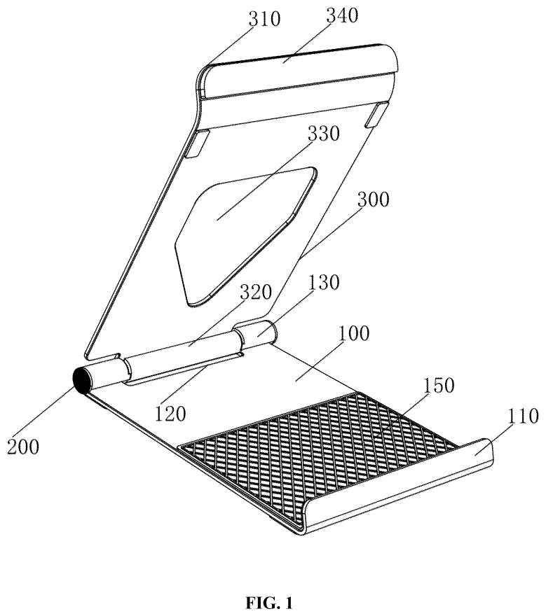

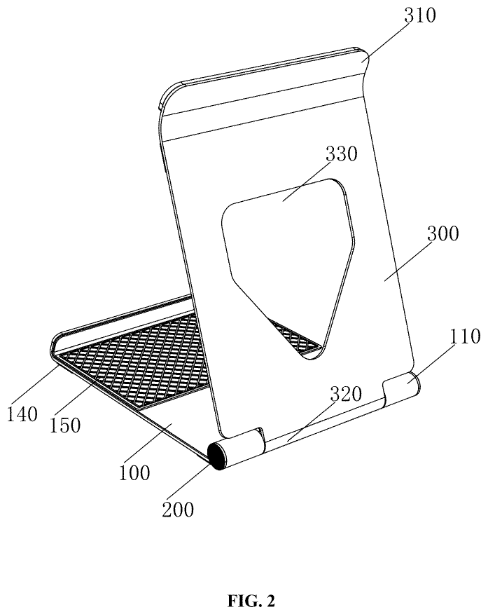

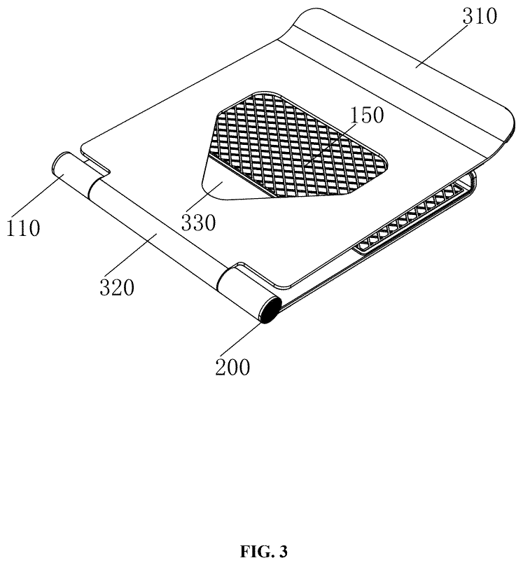

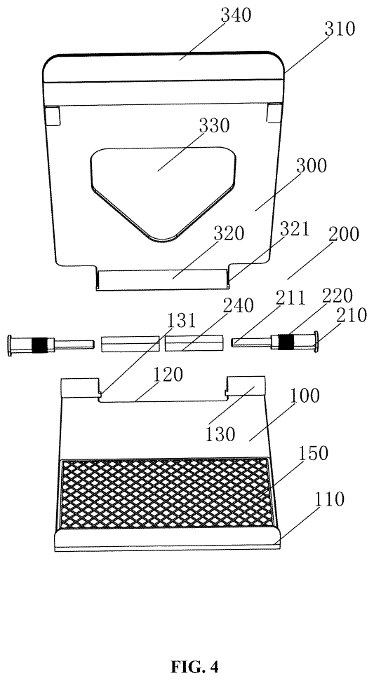

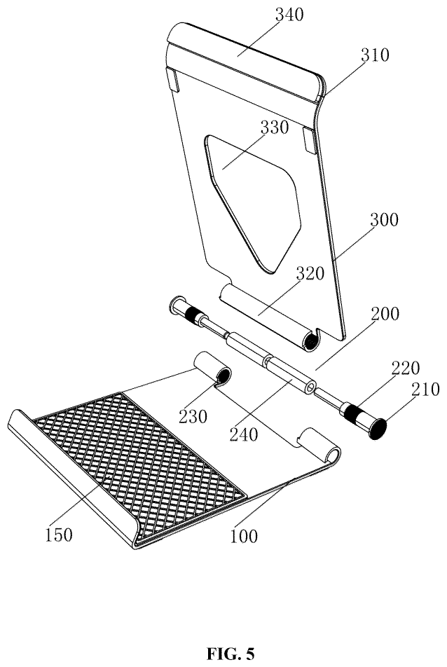

Referring to FIG. 1 to FIG. 5, the present disclosure provides a technical solution: a desktop adjustable hardware bracket includes a bottom plate 100. An upwards bent first flange portion 110 is arranged at one end of the bottom plate 100, and a U-shaped slot 120 is provided in another end of the bottom plate 100. First shaft sleeves 130 formed by inwards curling a plate body are arranged on two sides of a notch of the U-shaped slot 120. An interior of the U-shaped slot 120 and interiors of the first shaft sleeves 130 are connected with a supporting plate 300 through a stop-at-any-position rotating shaft mechanism 200 mounted. A backwards bent second flange portion 310 is arranged at one end of the supporting plate 300. A second shaft sleeve 320 is formed at another end of the supporting plate 300 by inwards curling a plate body. The second shaft sleeve 320 is in sleeving connection with the stop-at-any-position rotating shaft mechanism 200.

Specifically, during use of the desktop adjustable hardware bracket, the bottom plate 100 is placed on a desktop. The silicone pads 140 at the bottom of the bottom plate 100 achieves an anti-slip and stabilization effect, and the first anti-slip silicone sheets 150 at the top of the bottom plate 100 and on the inner side of the first flange portion 110 can prevent a placed electronic device from sliding on the bottom plate.

When an angle of the supporting plate 300 needs to be adjusted, the supporting plate 300 can rotate around the stop-at-any-position rotating shaft mechanism 200, so that the supporting plate 300 can start to rotate and stop the rotation at any position. Meanwhile, the first shaft sleeves 130 at one end of the bottom plate 100 cooperate with the stop-at-any-position rotating shaft mechanism 200 to provide a connection and supporting basis for the rotation of the supporting plate 300, so that the bracket can meet requirements of different electronic devices for supporting angles through the rotation of the supporting plate 300.

In this embodiment, the stop-at-any-position rotating shaft mechanism 200 includes two T-shaped shaft levers 210 that are respectively in interpenetrating connection to the interiors of the two first shaft sleeves 130. A first meshing tooth 220 is arranged on an outer side of a lever body of each T-shaped shaft lever 210. The first meshing tooth 220 is in meshing connection with a second meshing tooth 230 arranged inside each first shaft sleeve 130. An insertion shaft body 211 is arranged at one end of the lever body of the T-shaped shaft lever 210. A friction sleeve 240 made of a polyformaldehyde material sleeves the insertion shaft body 211. The friction sleeve 240 is sleeved inside the second shaft sleeve 320.

Specifically, when the supporting plate 300 is rotated, the first meshing teeth 220 and the second meshing teeth 230 mesh with each other and do relative motion, to provide a resistance and positioning basis for the rotation. Meanwhile, a friction force is generated between the friction sleeves 240 and the metal T-shaped shaft levers 210 inside. In combination with the action of the meshing teeth, a sufficient resistance is jointly generated, so that the supporting plate 300 can stably stop when it is rotated to any angle, thus meeting supporting requirements in different angles, without an additional locking operation.

In this embodiment, a positioning protrusion 131 is arranged on an inner side of one end of each first shaft sleeve 130; and positioning grooves 321 that adapt to the positioning protrusions 131 and limit a rotation range are arranged on outer sides of two ends of the second shaft sleeve 320.

Specifically, in the process that the supporting plate 300 is rotated around the stop-at-any-position rotating shaft mechanism 200, when the positioning protrusions 131 rotate within the positioning grooves 321, the rotation range can be limited, thus preventing excessive rotation of the supporting plate 300, avoiding damage to a structure of the bracket or a failure of normally supporting an electronic device because of a large rotation angle, ensuring that the supporting plate 300 is rotated within an appropriate angle range, and guaranteeing the stability and safety of use of the bracket.

In this embodiment, four corners of a bottom of the bottom plate 100 are fixedly connected with a plurality of silicone pads 140; and a top of the bottom plate 100 and an inner side of the first flange portion 110 are fixedly connected with first anti-slip silicone sheets 150.

Specifically, the silicone pads 140 at the four corners of the bottom of the bottom plate 100 increase the friction force with a desktop, which effectively prevents the bottom plate 100 from sliding on the desktop and stably place the entire bracket. The first anti-slip silicone sheets 150 increases the friction force between a placed electronic device and the bottom plate 100, thus avoiding the electronic device from sliding on the bottom plate 100 because of accidental touch or the like, providing a stable and reliable supporting plane for the placement of the electronic device on the bottom plate, and improving the safety of use.

In this embodiment, a hollow slot 330 is formed in a surface of the supporting plate 300; and the surface of the supporting plate 300 and a surface of the second flange portion 310 are fixedly connected with second anti-slip silicone sheets 340.

Specifically, the hollow slot 330 formed in the surface of the supporting plate 300 can reduce the weight of the entire bracket and does not affect the supporting strength. The second anti-slip silicone sheets 340 can increase the friction force between an electronic device and the supporting plate 300, thus preventing the electronic device from sliding on the supporting plate 300, so that the electronic device can be ensured to be stably placed when it is in different inclination angles. This improves the stability of supporting the electronic device by the bracket and meets supporting requirements in different usage scenarios.

In a preferred solution of the present disclosure, the bottom plate 100, the supporting plate 300, and the insertion shaft body 211 are made of metal materials.

Specifically, the bottom plate 100, the supporting plate 300, and the insertion shaft body 211 that are made of the metal materials can bear the weight of an electronic device and various forces generated during use, to ensure the structural stability of the bracket. Meanwhile, the metal materials have good wear resistance, so that during long-term operation of a rotating component such as the stop-at-any-position rotating shaft mechanism 200, the wear can be reduced, and the service life of the bracket can be prolonged, causing the bracket to stably support the electronic device for a long time.

Content that is not described in detail in this specification belongs to the existing technology known to those skilled in the art. Although the present disclosure has been described in detail with reference to the foregoing embodiments, those skilled in the art can still make modifications to the technical solutions described in the foregoing respective embodiments or make equivalent replacements to some technical features therein. Any modification, equivalent replacement, improvement, and the like made within the spirit and principle of the present invention shall fall within the protection scope of the present disclosure.

What is claimed is:

1. A desktop adjustable hardware bracket, comprising a bottom plate (100), wherein an upwards bent first flange portion (110) is arranged at one end of the bottom plate (100), and a U-shaped slot (120) is provided in another end of the bottom plate (100); first shaft sleeves (130) formed by inwards curling a plate body are arranged on two sides of a notch of the U-shaped slot (120); an interior of the U-shaped slot (120) and interiors of the first shaft sleeves (130) are connected with a supporting plate (300) through a stop-at-any-position rotating shaft mechanism (200) mounted; a backwards bent second flange portion (310) is arranged at one end of the supporting plate (300); a second shaft sleeve (320) is formed at another end of the supporting plate (300) by inwards curling a plate body; and the second shaft sleeve (320) is in sleeving connection with the stop-at-any-position rotating shaft mechanism (200).

2. The desktop adjustable hardware bracket according to claim 1, wherein the stop-at-any-position rotating shaft mechanism (200) comprises two T-shaped shaft levers (210) that are respectively in interpenetrating connection to the interiors of the two first shaft sleeves (130); a first meshing tooth (220) is arranged on an outer side of a lever body of each T-shaped shaft lever (210); the first meshing tooth (220) is in meshing connection with a second meshing tooth (230) arranged inside each first shaft sleeve (130); an insertion shaft body (211) is arranged at one end of the lever body of the T-shaped shaft lever (210); a friction sleeve (240) made of a polyformaldehyde material sleeves the insertion shaft body (211); and the friction sleeve (240) is sleeved inside the second shaft sleeve (320).

3. The desktop adjustable hardware bracket according to claim 1, wherein a positioning protrusion (131) is arranged on an inner side of one end of each first shaft sleeve (130); and positioning grooves (321) that adapt to the positioning protrusions (131) and limit a rotation range are arranged on outer sides of two ends of the second shaft sleeve (320).

4. The desktop adjustable hardware bracket according to claim 1, wherein four corners of a bottom of the bottom plate (100) are fixedly connected with a plurality of silicone pads (140); and a top of the bottom plate (100) and an inner side of the first flange portion (110) are fixedly connected with first anti-slip silicone sheets (150).

5. The desktop adjustable hardware bracket according to claim 1, wherein a hollow slot (330) is formed in a surface of the supporting plate (300); and the surface of the supporting plate (300) and a surface of the second flange portion (310) are fixedly connected with second anti-slip silicone sheets (340).

6. The desktop adjustable hardware bracket according to claim 2, wherein the bottom plate (100), the supporting plate (300), and the insertion shaft body (211) are made of metal materials.
